(19) United States
(12) Patent Application Publication
(10) Pub. No.: US 2023/0405507 A1
(43) Pub. Date: Dec. 21, 2023

(54) CORRUGATED HELICAL SHAPED FILTER MEDIA

(71) Applicants: Robb Patrick BENSON, Montgomery, TX (US); Allan James ALDEN, Stacy, MN (US); James Nathan HERRIN, Canroe, TX (US); Martin Gene MILLER, Montgomery, TX (US); Majid ZIA, White Bear Lake, MN (US)

(72) Inventors: Robb Patrick BENSON, Montgomery, TX (US); Allan James ALDEN, Stacy, MN (US); James Nathan HERRIN, Canroe, TX (US); Martin Gene MILLER, Montgomery, TX (US); Majid ZIA, White Bear Lake, MN (US)

(21) Appl. No.: 18/247,686

(22) PCT Filed: Oct. 6, 2021
(86) PCT No.: PCT/US21/53763

§ 371 Date: Apr. 3, 2023

Related U.S. Application Data
(60) Provisional application No. 63/088,567, filed on Oct. 7, 2020.

(51) Int. Cl. B01D 46/52; B01D 46/02

(52) U.S. Cl. CPC B01D 46/521; B01D 46/02

(57) ABSTRACT

A filter media is formed into a filter bag for fluid filter elements. A long tube of filter media is formed into a helix or a pleated structure with a corrugated cross-section to increase the surface area of filter media area that can fit into a given volume. A retaining structure can be used to maintain the shape of the filter media.

### BACKGROUND

The present invention relates to a tubular shaped filter. Tubular shaped filters, commonly referred to as bag filters, are well known and have been utilized to remove contaminants from liquid and gas streams for many years. Generally, a tubular shaped filter contains filter media that has been formed into a tube with one end of the tube attached to a ring or other means to keep that end of the filter open and the other end of the tube is typically sealed or closed off. These tubular shaped filters are typically inserted into a rigid tubular shaped perforated cage to support the filter during service. The filters are preferably flexible so they can fit the shape of rigid tubular shaped perforated cages from various manufacturers. The filtration surface area of these tubular shaped filters is defined as the surface area of the cylinder-shaped tube of media leaving the entire internal cylindrical volume substantially open and void of filter media. As a result, a nominal standard size #2 bag filter has about 5 square feet of surface area and about 7 square feet of filter media per cubic foot of occupied cage space.

There are many alternative filters designed to fit into the same space as a tubular shaped filter, such as pleated cartridges and extended surface area bag filters, that offer more filtration surface area than a tubular shaped filter. The added filtration surface area of these filter designs increases the service life of the filter as compared to the tubular shaped filters. This is beneficial in that increasing the service life of the filter can decrease the number of times the filters need to be purchased and replaced. Although these alternative filter designs offer longer service life, they can also have additional costs due to the use of substantial end caps, added support structures and or added labor to fabricate each filter as compared to the tubular shaped filters. The added costs are oftentimes greater than the gain service life making these alternative designs less economical than a tubular shaped filter.

Additionally, the pleated cartridges are rigid can be difficult to install or remove from the rigid tubular shaped perforated cages if there is an interference between the rigid filter and the rigid cage. There are numerous manufacturers of these cages, and each may use different internal diameters, lengths, and shapes for the bottom of the cages which can cause an interference with rigid pleated filters. The rigid tubular shaped perforated cages are typically thin-walled structures and are easily dented, bent, or become out-of-round causing an obstruction or interference between a rigid pleated filter and the rigid cage.

There are also extended surface area bag filters that are flexible and can easily fit into the rigid tubular shaped perforated cage, but they offer less filtration surface area than pleated cartridges. In some cases, replacement cages and or installation tools are required when using an extended surface area bag filter.

U.S. Pat. No. 1,741,705 discloses a filtering unit comprising a helical frame surrounded by an envelope of filtering material which is drawn inwardly between the adjacent turns of the helix by means of a wire or the like. When such a filtering unit is used for outside-in filtration it sometimes happens that adjacent sections of the filtering material are pressed into contact and by that much reduces the effective filtering area. The frame and filter comprise an integral unit in this early design in which a cord wraps a media around a helical frame and the media is first folded along its axis.

U.S. Pat. No. 8,236,210 discloses a method of making a helical filter, but this filter does not use a support cord.

U.S. Pat. No. 4,842,739 discloses a high surface area filter cartridge. These filter cartridges comprise a nested arrangement of disk-shaped filter layers having a pattern of regular radial pleats. A secondary pattern of irregular wave like radial pleats generally results from packing of the structure around the inner circumference of the disk-shaped layers to form the filter cartridge.

U.S. Pat. No. 4,863,602 shows a flexible filter element with bypass. This patent shows a disposable filter element including a plurality of layers of flexible semi-permeable material and a non-filtering transport layer and another layer of filtering material upstream.

### SUMMARY OF THE INVENTION

The present invention provides a novel form of filter media formed into a corrugated helical shape for liquid and gas filter elements. More particularly the invention relates to a long tube of filter media formed into a helix with a corrugated cross-section to increase the surface area of filter media area that can fit into a given volume.

According to the present invention, it is possible to provide up to 7 times, or more, filtration surface area than tubular shaped filters. The present invention can be manufactured with similar or even lesser costs for material and components as the tubular shaped filter and fit into the rigid tubular shaped perforated cages in the same manner as the tubular shaped filters. The increase filtration surface area increases service life of the invention that is greater than the increase in cost of the filter making it the more economical than the tubular shaped filter.

The corrugated helix may be supported with an integral spiral wound cord or cords to maintain the corrugated pleat spacing and prevent pleat collapse against the rigid tubular shaped perforated cage which would reduce the service life of the filter. The corrugated helix shape is flexible in both the radial and longitudinal direction which allows it to fit within new or existing rigid tubular shaped perforated cages by various manufacturers.

The corrugated helix/pleats can run essentially the entire length of the filter, or may run only a portion of the axial length of the filter.

Pleated cartridges use rigid end caps to encapsulate the pleated filter media. The outside diameters of pleated cartridges need to be smaller than the inside diameter of the rigid tubular shaped perforated cage to prevent interference with cages from different manufacturers or damaged cages. The gap between the pleated cartridge and cage leaves the pleated filter media unsupported. As a result, pleated cartridges require integral outer retainers to support the pleated media which add costs and takes away volume that could be used for filtration surface area.

The present invention can be installed into existing rigid tubular shaped perforated cages without the need for new cages or special installation tools. Known extended surface area bag filters often need new cages or adaptors before they can be used in existing vessels.

A strap can be added that connects the bottom of the present invention to the top to allow the filter to be removed from the rigid tubular shaped perforated cage without uncoiling. The strap can be adhered to the corrugated helical media to further support the filter media which can make installing and removing the filter from cage easier.

The pitch of the corrugated helix shape can be compressed or expanded to fit a variety of cages styles and services.

The corrugated helix can be formed in a clockwise or counterclockwise direction.

The corrugated filter media can be one layer of media or multiple layers of media.

The corrugated filter media can be woven or non-woven.

In at least one embodiment of the present invention a reusable inner support cage may be inserted into the corrugated filter.

In another embodiment of the invention, a long tube of filter media can be formed into a series of radial lobes with a corrugated cross-section to increase the surface area of filter media area that can fit into a given volume. The corrugated radial lobes can be formed by gathering the filter media at designated intervals. The gathered filter media can be kept in place by use of a cord or ring. A strap can be added that connects the bottom of the filter to the top to allow the filter to be removed from the rigid tubular shaped perforated cage without uncoiling. The strap can be adhered to the radial lobes to further support the filter media which can make installing and removing the filter from cage easier.

The resulting corrugated radial lobed structure can provide the same filtration performance, flexibility, ease of use and economics as the corrugated helical shaped filter media.

### BRIEF DESCRIPTION OF THE DRAWINGS

The invention is disclosed further by the attached drawings.

FIG. 1 is a diagrammatic view of a prior art tubular shaped filter.

FIG. 2 is a cross-sectional view along line 1-1 of FIG. 1.

FIG. 3 is a diagrammatic view of a known rigid tubular shaped perforated cage.

FIG. 4 is a diagrammatic view of a known rigid tubular shaped perforated cage with a cutaway showing a tubular shaped filter installed inside the cage.

FIG. 5 is a diagrammatic view of a prior art pleated filter.

FIG. 6 is a cross-sectional view along line 2-2 of FIG. 5.

FIG. 7 is a diagrammatic view of a known rigid tubular shaped perforated cage with a flat shaped bottom.

FIG. 8 is a diagrammatic view of a known rigid tubular shaped perforated cage with a dome shaped bottom.

FIG. 9 is a diagrammatic view of a known rigid tubular shaped perforated cage with a cone shaped bottom.

FIG. 10 is a diagrammatic view of a corrugated helical shaped filter according to the present invention.

FIG. 11 is a cross-sectional view along line 3-3 of FIG. 10.

FIG. 12 is a cross-sectional view of a corrugated helical shaped filter installed in a rigid tubular shaped perforated cage.

FIG. 13 is a diagrammatic view of a filter with an array of radial lobes according to the present invention.

FIG. 14 shows a cut-away view of an embodiment of a filter according to the present invention inside a known rigid tubular shaped cage with a flat shaped bottom.

FIG. 15 shows a cut-away view of an embodiment of a filter according to the present invention inside a known rigid tubular shaped cage with a dome shaped bottom.

FIG. 16 shows a cut-away view of an embodiment of a filter according to the present invention inside a known rigid tubular shaped cage with a cone shaped bottom.

FIG. 17 shows an embodiment of the present invention including a support strap.

FIG. 18 is a cross sectional view along line 4-4 in FIG. 17.

### DETAILED DESCRIPTION OF THE PREFERRED EMBODIMENTS

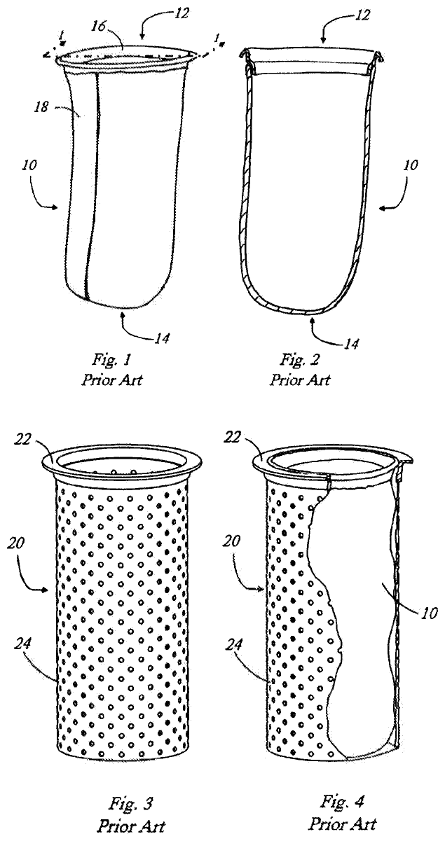

FIGS. 1 and 2 show a standard known tubular shaped filter according to the prior art. A filter 10 has an open end 12 and a closed end 14. The open end of the filter has an open support ring 16 which is typically a plastic or metallic ring of various sizes and shapes and attaches to a filter media 18. The support ring 16 can be attached to the filter media 18 using adhesive, sewn using thread, riveted, thermally welded, or wrapped with the filter media, among other methods known in the art.

FIGS. 3 and 4 shows a rigid tubular shaped perforated cage 20, known as a filter support cage. The filter support cage 20 is designed to hold a compatible filter. Shown in FIG. 4 is a cut away image of the filter support cage 20 containing a known tubular shaped filter 10. A ring 22 can be attached to the filter support cage and can be used to hold an open support ring 16. The filter support cage 20 will typically have a plurality of openings or holes 24 so that fluids can pass through.

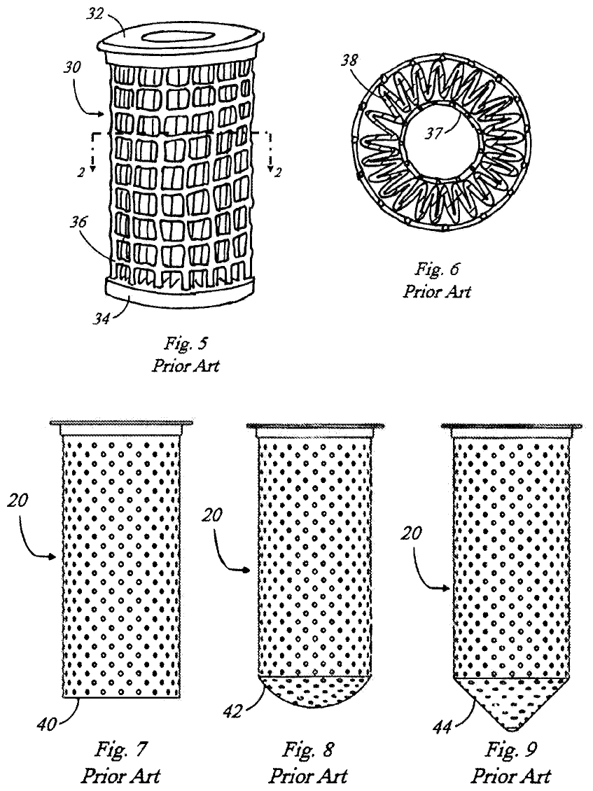

FIGS. 5 and 6 show a known pleated cartridge 30. The pleated cartridge 30 has a top end 32 and a bottom end 34 which are typically similar or the same in size. The pleated cartridge may have a rigid external retainer 36 and or a rigid center core 37. It can be seen in the cut-away view of FIG. 6 that the pleats 38 run vertically along the length of the filter 30.

Pleated cartridges can offer more filtration surface area of filter media and fit into the same space as the tubular shaped filters. The added surface area of the pleated filter can increase the service life of the filter as compared to the tubular shaped filters. Increasing the service life of the filter decreases the number of times the filters need to be replaced. Although these pleated cartridge designs offer longer service life, they also have additional costs due to the use of two substantial end caps, added support structures and added labor to fabricate each filter as compared to the tubular shaped filters. The added costs lead to an increase in sell price and oftentimes the longer service life is not enough to justify the higher sell price. Additionally, the pleated cartridges are rigid can be difficult to install or remove from the rigid tubular shaped perforated cages if there is an interference between the rigid filter and rigid cage.

FIGS. 7-9 show variations of known rigid tubular shaped perforated cages 20. FIG. 7 shows a cage with a flat shaped bottom 40, FIG. 8 shows a dome shaped bottom 42, and FIG. 9 shows a cone shaped bottom 44. Embodiments of the present invention can be compatible with each of these known cages thus not requiring a specific design for each type of cage, minimizing costs and inventory.

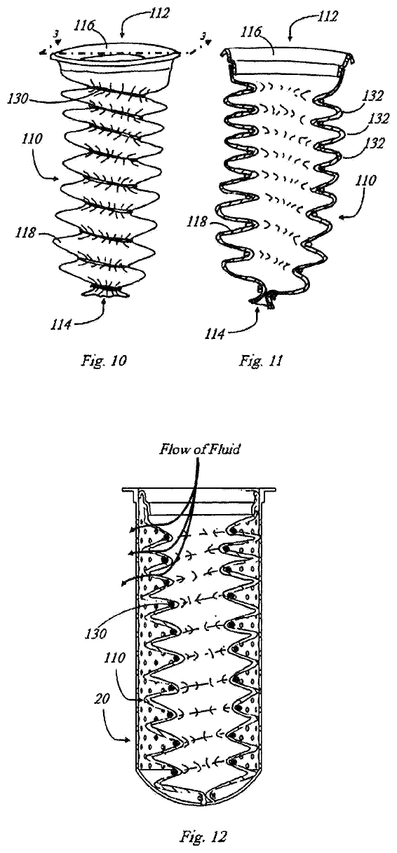

An embodiment of a filter according to the present invention is shown in FIGS. 10 and 11. A filter 110 is shown with an open end 112 and a closed end 114. An open support ring 116 holds the open end 112 of the filter open and can be attached to the filter media 118 by any means known in the art. The corrugated helical pleated structure or pleats 132, which extend along the length of the filter, in what may be described as an “accordion-like” structure. In a preferred embodiment of the present invention the filter media can be formed into a long tube with an outer diameter substantially the same as the inner diameter of the perforated cage. The long tube can then be formed into a corrugated helix as shown. When the filter media is formed into a corrugated helix it allows for the filter media to fit into the same rigid tubular perforated cage as the tubular filters.

As shown on FIG. 10, the closed end of the filter 114 can be substantially smaller than known pleated cartridges. This smaller end can result in less use of rigid materials reducing cost and increasing ease of use compared to known filters. The closed end of the filter media can be created by various means including heat welding, sonic welding, radio frequency welding, adhesives, stitching, etc. The closed end can also be formed by using a separate part, such as a cap, that is attached to the end of filter media tube. The closed end of the filter media can also be tied off by the cord that is used to wrap around the element or a separate cord.

In accordance with the invention, at least one cord 130 is wrapped around the outside of the filter media to help the filter retain its “accordion” shape. In this embodiment, the cord is an integral part of the filter and is essential to provide structural stability to prevent pleat collapse under flow induced differential pressure across the filter. Integral is defined as a unit with another component. The cord may be rewound with another cord or a different cord for various structural strengths and chemical compatibilities. The cord may be a rope, twine, string, wire, cable and or chain, can be monofilament, multi-filament, braided, twisted, woven, or non-woven, can consist of one or more materials such as a cord impregnated with adhesive and sizing agents. In embodiments of the present invention, the cord can be replaced with a semi-rigid or rigid materials such as an extruded thermoplastic rod or a rigid material such as a metallic spring or coil. Also, in conjunction with embodiments of the present invention, the cord could be a reusable part that is installed prior to service and then removed after service so it can used again. Further to this, the cord can be completely removed from the corrugated helical filter.

This at least one cord 130 can help the filter hold its shape during service preventing the media from expanding out and flattening against the tubular perforated cage which can reduce the service life and or filtration efficiency of the filter.

Instead of using a cord, the corrugated helical shape can also be fixed using an adhesive bead along the inner helical path, or it can be sewn/stitched, or thermally formed by melting the filter media for any combination of these together.

FIG. 12 shows a cut-away rigid tubular shaped perforated cage 20 with a filter 110 and cord 130 according to the present invention. This figure shows the preferred direction of fluid flow into the filter media, through the media and out through the perforations in the housing. The filter may be used with and without an inner support structure in reverse fluid flow (outside-in). The inner support structure may be in a form of a cord or cage.

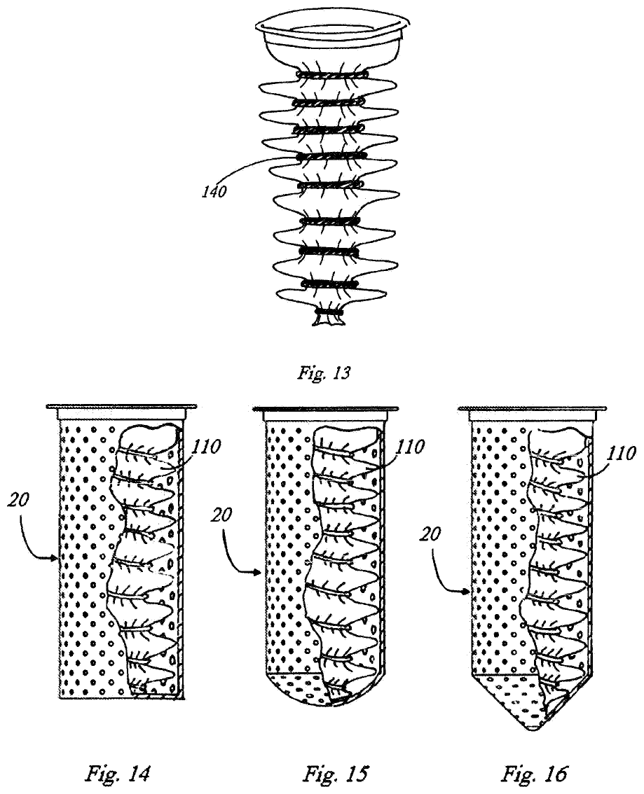

FIG. 13 shows an alternative embodiment of the present invention. In this embodiment, the filter media is formed into a series of radial lobes 140 forming an “accordion-like” structure. The radial lobes can be created by gathering the media with a linear array of rings. The rings could be formed with a cord like material or other variations as described in the embodiments above including flexible, semi-rigid and rigid materials.

FIGS. 14-16 shows an embodiment of a filter according to the present invention disposed within known rigid tubular shaped perforated cages of various designs. The present invention is flexible in both the radial and longitudinal directions allowing the filter to fit into various cage designs.

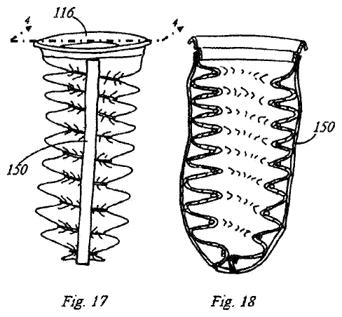

FIGS. 17 and 18 show an embodiment of the present invention including a support strap 150. The strap 150 can be added so that it connects the bottom of the filter to the top to allow the filter to be removed from the rigid tubular shaped perforated cage without uncoiling. The strap 150 can be a flat strip of material or a cord such as a rope, twine, string, wire, or a cable, can be monofilament, braided, twisted, woven, or non-woven, can be consist of or more materials such as a cord impregnated with an adhesive.

In embodiments of the present invention, there can be one strap or multiple straps and the straps can be located on the outside or inside of the filter. The straps 140 can be attached directly to the end cap of the filter or to the filter media itself. The closed end of the filter media can be created by various means including heat welding, sonic welding, radio frequency welding, adhesives, stitching, etc.

The corrugated helix or radial lobes can also be tapered such that the outside diameter reduces slightly from the open end to the closed end. The taper can make the installation of the corrugated helical filter media easier to install and remove from the tubular perforated cage.

The entire filter can be placed into a permeable containment tube substantially the shape of the tubular shaped filter. The containment tube can be woven, extruded, non-woven or perforated.

Compared to known tubular shaped filters, the filters of the present invention offer more filtration surface area and fit into existing rigid tubular shaped perforated cages while not substantially increasing the cost over tubular shaped filters. The present invention can be manufactured at a cost savings to known pleated cartridges, gaining the advantages of longer service life of the filter without the added costs of one or more substantial end caps, without one or more substantial supporting structures and with less additional labor needed to fabricate each filter. Additionally, known pleated cartridges are rigid can be difficult to install or remove from the rigid tubular shaped perforated cages if there is an interference between the filter and cage. The flexible design of the present invention allows better fit into the existing housings, and better ease of use.

In accordance with the provisions of the patent statutes, the present invention has been described in what is considered to represent its preferred embodiments. However, it should be noted that the invention can be practiced otherwise than as specifically illustrated and described without departing from its spirit or scope.

1. A filter for use for separating constituent components of a fluid mixture, said filter comprising:
a porous media material for filtration of fluids, wherein the porous material has a helically pleated shape comprising a corrugated cross-section; and
the filter defining an axial length along the largest dimension of the filter; wherein
the corrugated cross-section extends a substantial portion of the axial length of the filter.

2. The filter according to claim 1, further comprising at least one integral support structure which is positioned so as to maintain the helical corrugated shape.

3. The filer according to claim 2, wherein the at least one integral support structure extends helically along an external surface of the porous material.

4. The filter according to claim 2, wherein the at least one integral supporting structure comprises multiple support structures.

5. The filter according to claim 2, wherein the at least one supporting structure is at least one of a flexible cord, a semi-rigid material, and/or a rigid material.

6. The filter according to claim 1, wherein there is at least one retaining strap that extends substantially the axial length of the filter.

7. The filter according to claim 6, wherein at least one retaining strap extends from one end of the filter to the other end of the filter.

8. The filter according to claim 6, wherein the at least one restraining strap comprises multiple retaining straps, each of which retaining straps is disposed along an exterior portion of the filter and/or an interior portion of the filter.

9. The filter according to claim 8, wherein at least one of the multiple retaining straps are adhered to the helical corrugated filter media.

10. The filter according to claim 1, further comprising:
a closed end at one end of the filter media; and
an open end at the end of the filter media opposite the closed end to allow fluid to enter the filter;
a flexible support structure extending helically around an external surface of the porous media; and
at least one retaining strap that extends from the open end of the filter to the closed end of the filter.

11. The filter according to claim 1, wherein the porous material has substantially more filtration surface area of tubular filter of the same length.

12. The filter media according to claim 1, wherein the corrugated filter media is designed to fit into a standard filter cage.

13. The filter according to claim 1 wherein the corrugated filter media comprises a series of pleats, with each of said series of pleats comprises a substantially V-shape, with an annular region and two extending sides, and wherein the at least one supporting cord runs substantially the axial length of the filter media and is disposed within the annular region of each of the pleats.

14. A filter for use for separating constituent components of a fluid mixture, said filter comprising:
a porous media material for filtration of fluids, wherein the porous material has a radially pleated shape comprising a corrugated cross-section; and
the filter defining an axial length along the largest dimension of the filter; wherein
the corrugated cross-section extends a substantial portion of the axial length of the filter.

15. The filter according to claim 14, wherein at least one ring is axially positioned so as to maintain the radially pleated corrugated shape.

16. The filer according to claim 15, wherein the at least one ring is disposed on an external surface of the porous material.

17. The filter according to claim 15, wherein the at least one ring is at least one of a flexible cord, a semi-rigid material and/or a rigid material.

18. The filter according to claim 14, wherein there is at least one retaining strap that extends substantially the axial length of the filter

19. The filter according to claim 18, wherein one or more of the at least one retaining straps is adhered to the radially pleated filter media.

20. A filter for use for separating constituent components of a fluid mixture, said filter comprising:
a porous media material for filtration of fluids, wherein the porous material has a helically pleated shape comprising a corrugated cross-section; and
a closed end at one end of the filter media; and
an open end at the end of the filter media opposite the closed end to allow fluid to enter the filter
at least one integral support structure which is positioned so as to maintain the helical corrugated shape; and
a retaining strap that extends substantially the axial length of the filter; wherein
the filter defining an axial length along the largest dimension of the filter; and
the corrugated cross-section extends a substantial portion of the axial length of the filter.
